(19) United States
(12) Patent Application Publication
(10) Pub. No.: US 2004/0089972 A1
(43) Pub. Date: May 13, 2004

(54) Method for producing monocomponent-microfilaments and obtaining a nonwoven, woven or knit fabric comprised of these microfilaments

(76) Inventors: Denis Reibel, Herrlisheim (FR); Robert Groten, Sundhofen (FR); Georges Riboulet, Colmar (FR)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/466,386

(22) PCT Filed: Jan. 16, 2002
(86) PCT No.: PCT/EP02/00390

(30) Foreign Application Priority Data
Jan. 19, 2001 (DE) 101 17 970.7

(51) Int. Cl. B29C 47/88

(52) U.S. Cl. 264/211.2

(57) ABSTRACT

The invention relates to a method for producing monocomponent-microfilaments comprised of multiple component filaments, particularly bi-component filaments, which are produced in a melt spinning method, whereby one of the components is melted out of the multiple component filaments by effecting a thermal treatment using a melt fluid.

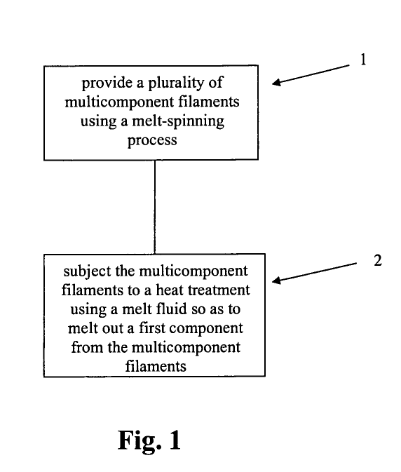

### DESCRIPTION

The present invention relates to a method of producing monocomponent microfilaments from multicomponent filaments produced by the melt-spinning process, in particular from bicomponent filaments.

It is known that microfilaments are produced by splitting multicomponent filaments mechanically or by using solvents. The resulting microfilaments are many times thinner than the unsplit filaments. The filaments may be split so that individual components remain, or one component may be removed by the solvent splitting process, so that then a monocomponent microfilament is obtained. Various methods are known for mechanical splitting of filaments, including splitting by using a strong water jet. To make this possible, splittable filaments are formed from incompatible components, frequently using polyesters and polyamides. However, the incompatibility of the polymers makes it difficult to perform the subsequent finishing of the microfilaments and the fabrics manufactured from them. For example, the dying properties of the individual components vary greatly, which could become a problem in the finished product. This problem is eliminated with monocomponent microfilaments produced by the solvent splitting process in which one component is dissolved out.

### BACKGROUND INFORMATION

Japanese Patent Application 55076110 A describes the use of a polyester produced from polyethylene terephthalate, combined with a polyamide, as the splitting component. The polyester is spun with the polyamide to form a filament, and the resulting yarn is treated with an aqueous alkali to dissolve out the polyester, thus yielding polyamide microfilaments.

European Patent Application 0 618 316 A1 describes another possibility of producing microfibers by using two different polymers, one being a water-insoluble polyolefin and the other being a water-soluble polymer. The latter is a polyvinyl alcohol. The water-soluble polymer is dissolved out by aqueous treatment of the microfilaments or the material produced therefrom.

A comparable process is described in European Patent Application 0 618 317 A1 in which the water-insoluble polymer is a polyester-polyamide or copolymer thereof, and the water-soluble polymer is a bifunctional dicarboxylic acid.

European Patent Application 0 498 672 A2 describes microfibers produced by the melt-blowing process, in which the components of the filament to be split are thermoplastic polymers, one of which is removable using a solvent while the other is insoluble in the solvent. Polypropylene is used as the insoluble polymer and polyvinyl alcohol is the soluble polymer to be removed with the solvent, which is water. The soluble polymer may be removed before, during, or after production of the woven or nonwoven material. It is a disadvantage in this process that finite fibers, which do not have the same strength as continuous filaments, are produced by the melt-blowing process.

### EXPLANATION OF THE INVENTION

The object of the present invention is to provide a method of producing monocomponent monofilaments from multicomponent filaments produced by melt-spinning processes, that is simple to implement and highly economical.

This object is achieved according to the present invention with the method of the type defined in the preamble by dissolving one component out of the multicomponent filament by a heat treatment using a melt fluid. The high-melting water-insoluble component used in this process may be a polyester, polyamide, polyolefin, polypropylene or copolymers thereof, depending on the material produced subsequently from the microfilaments.

The readily meltable component is a low-melting, melt-spinnable polymer from the classes of polyolefins, polyesters, polyamides, polyurethanes or copolymers thereof. ε-Caprolactone was used as an example.

It is advantageous if the low-melting component has a melting point below 110° C., preferably below 80° C. This allows the use of a melt fluid having a relatively low temperature, but at least 20° C. above the melting point of the low-melting component.

Water with or without an agent for elevating the boiling point may be used as the melt fluid.

The melting process preferably takes place after mechanized or hydromechanical bonding in the case of nonwovens. A highly economical operation is possible if the low-melting component is recovered from the melt fluid. Recovery is performed by cooling the melt fluid, then recrystallizing, separating, drying and regranulating. This cycle may be repeated multiple times, e.g., up to 10 times in the case of poly-ε-caprolactone. Denitrification may be performed to recover spent poly-ε-caprolactone.

The configuration of the multicomponent filaments viewed in cross section is preferably selected so that the microfilaments formed by the melt process are accessible to the melt fluid from the outside.

A knit, woven or nonwoven fabric may be manufactured from microfilaments produced by the method described above, and then the low-melting component of the filament is melted out by a hot hydromechanical treatment. This is particularly advantageous in the manufacture of a nonwoven material, because the nonwoven is fluid jet bondable.

The implementation of this method is described below on the basis of an exemplary embodiment.

A PIE filament having 16 alternating segments of 70% PET and 30% PCL is spun-laid to form a nonwoven and bonded (hydro)mechanically.

Superheated steam acts on the web from above, flowing through the nonwoven, melting and entraining PCL downward into an aqueous collecting bath at room temperature.

The molten PCL is immediately recrystallized, collected, dried, and recycled back to the process, supplying it to the extruder at the top, after an optional reshaping step (regranulation). This yields a monocomponent microfilament nonwoven having a low density and good drapability because of the free volume previously taken up by the PCL.

What is claimed is:

1. A method of producing monocomponent microfilaments from multicomponent filaments, in particular bicomponent filaments produced by the melt-spinning process,
wherein one component is melted out of the multicomponent filaments by a heat treatment using a melt fluid.

2. The method of producing monocomponent microfilaments as recited in claim 1,
wherein the component melted out of has a melting point below 110° C., preferably below 80° C.

3. The method of producing monocomponent microfilaments as recited in claim 1 or 2, wherein the component melted out is a poly-ε-caprolactone or another low-melting melt-spinnable polymer.

4. The method of producing monocomponent microfilaments as recited in one of claims 1 through 3,
wherein a melt fluid whose temperature is at least 20° C. above the melting point of the component which is melted out of the filament is used for the dissolving process.

5. The method of producing monocomponent microfilaments as recited in one of claims 1 through 4,
wherein water with or without an agent for elevating the boiling point is used as the melt fluid.

6. The method of producing monocomponent microfilaments as recited in one of claims 1 through 5,
wherein an agent for elevating the boiling point is added to the water.

7. The method of producing monocomponent microfilaments as recited in one of claims 1 through 6,
wherein the component melted out is recovered from the melt fluid.

8. The method of producing monocomponent microfilaments as recited in claim 7, wherein the recovery of the component melted out is performed by cooling the melt fluid, recrystallizing, separating, and optionally granulating.

9. The method of producing monocomponent microfilaments as recited in claim 1, wherein the component that is not melted out is a polyester, a polyamide, a polyolefin, polyurethane or copolymers thereof.

10. The method of producing monocomponent microfilaments as recited in one of claims 1 through 9,
wherein the melting operation takes place after the (hydro)mechanical bonding of a nonwoven.

11. Knit, woven or nonwoven fabrics produced by the process as recited in claims 1 through 13.
